(19) United States
(12) Patent Application Publication
(10) Pub. No.: US 2015/0065126 A1
(43) Pub. Date: Mar. 5, 2015

(54) METHOD FOR CONNECTING TO NETWORK AND ELECTRONIC DEVICE THEREOF

(71) Applicant: Samsung Electronics Co., Ltd., Suwon-si (KR)

(72) Inventors: Bu-Seop JUNG, Suwon-si (KR); Edwin Joseph Vimal BASTIN, Bangalore (IN); Ji-Hyun JUNG, Anyang-si (KR)

(21) Appl. No.: 14/471,708

(22) Filed: Aug. 28, 2014

(30) Foreign Application Priority Data
Aug. 28, 2013 (KR) 10-2013-0102553

(51) Int. Cl. H04W 48/16; H04W 88/08

(52) U.S. Cl. CPC H04W 48/16; H04W 88/08
USPC 455/434

(57) ABSTRACT

A method for connecting to a network in an electronic device is provided. The method includes generating a list of Access Points (APs) to which the electronic device fails to connect upon AP connection, when APs are scanned, classifying the scanned APs into a first group and a second group based on the list, and omitting performance of a discovery operation with an AP of the second group and performing the discovery operation with an AP of the first group, wherein the first group is a group of APs which are not included in the list.

### CROSS-REFERENCE TO RELATED APPLICATION(S)

This application claims the benefit under 35 U.S.C. §119(a) of a Korean patent application filed on Aug. 28, 2013 in the Korean Intellectual Property Office and assigned Serial No. 10-2013-0102553, the entire disclosure of which is hereby incorporated by reference.

### TECHNICAL FIELD

The present disclosure relates to a method for connecting to a network and an electronic device thereof

### BACKGROUND

With the recent rapid development of electronic devices, an electronic device capable of exchanging information or data is now readily available.

For example, an electronic device provides a near field wireless communication function, such as a Wi-Fi communication function or a wibro (or mobile wimax) communication function to enable a user to easily make a communication through the near field wireless communication function.

The electronic device detects an Access Point (AP) as a result of scanning, outputs an AP list, and establishes a connection with a selected AP (for example, input of authentication information).

Typically, the electronic device employs a technique of automatically performing network authentication without the user's intervention (for example, establishment operation) to connect to the AP.

In such a technique, the electronic device performs a discovery operation (Access Network Query Protocol (ANQP) query/response) of requesting information about APs that provide a wireless network from an ANQP) server for AP connection and attempts to connect to an AP matched with pre-stored user information. In this case, the AP matched with the pre-stored user information may be an AP that corresponds to the operator of a network that is used by the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for improving network discovery performance in an electronic device.

Another aspect of the present disclosure is to provide an apparatus and method for omitting performance of a discovery operation with an unnecessary Access Point (AP) in an electronic device.

Another aspect of the present disclosure is to provide an apparatus and method for omitting performance of a discovery operation with an AP which does not satisfying a predetermined reference quality among scanned APs in an electronic device.

In accordance with an aspect of the present disclosure, a method for connecting to a network in an electronic device is provided. The method includes generating a list of APs to which the electronic device fails to connect upon AP connection, when APs are scanned, classifying the scanned APs into a first group and a second group based on the list, and omitting performance of a discovery operation with an AP of the second group and performing the discovery operation with an AP of the first group, wherein the first group is a group of APs which are not included in the list.

In accordance with another aspect of the present disclosure, an electronic device is provided. The electronic device includes a memory configured to store user information and a list of discovery-unapplied APs, and a processor, wherein the processor includes a network connection module configured to perform a discovery operation with neighboring APs and an AP analysis module configured to identify APs, to which the electronic device is not connectable, based on a result of the discovery operation and user information upon AP connection and configured to generate a list of discovery-unapplied APs with respect to the APs to which the electronic device is not connectable.

In accordance with another aspect of the present disclosure, a computer-readable recording medium stores one or more programs for generating a list of APs to which the electronic device fails to connect upon AP connection, when APs are scanned, and for performing a discovery operation with an AP included in the list among the scanned APs.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will become more apparent from the following description taken in conjunction with the accompanying drawings, in which:

FIG. 1 is block diagram of an electronic device according to an embodiment of the present disclosure;

FIG. 2 is a diagram illustrating an operation of connecting to an Access Point (AP) in an electronic device according to an embodiment of the present disclosure;

FIG. 3 is a diagram illustrating an operation of connecting to an AP in an electronic device according to an embodiment of the present disclosure;

FIG. 4 is a flowchart illustrating a process of generating an AP list in an electronic device according to an embodiment of the present disclosure;

FIG. 5 is a diagram illustrating an operation of connecting to an AP in an electronic device according to an embodiment of the present disclosure;

FIG. 6 is a diagram illustrating an AP connection operation of an electronic device according to an embodiment of the present disclosure;

FIG. 7 is a flowchart illustrating an operation of connecting to an AP in an electronic device according to an embodiment of the present disclosure; and

FIG. 8 is a flowchart illustrating an operation of connecting to an AP in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the spirit and scope of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

With the recent rapid development of electronic devices, an electronic device capable of exchanging information or data is now readily available and known in the related art.

Such an electronic device may provide a near field wireless communication function, such as a Wi-Fi communication function or a wibro (or mobile wimax) communication function. Typically, the electronic device of the related art automatically performs a network authentication without the user's intervention (for example, establishment operation) to connect to an Access Point (AP).

The electronic device of the related art may perform a discovery operation (Access Network Query Protocol (ANQP) query/response) of requesting information about APs from an ANQP server for AP connection and connect to an AP matched with pre-stored user information. For example, an electronic device of the related art may identify operator information of a network of an AP by performing the discovery operation and perform a comparison to determine whether the operator information is matched with the pre-stored user information.

An electronic device of the related art may perform a discovery operation with all scanned APs, but the scanned APs may include an AP to which the electronic device is not connectable or an AP which does not satisfy a predetermined reference quality. As described above, the electronic device of the related art performs such a discovery operation with unnecessary APs, increasing an AP connection time and causing battery consumption.

An electronic device according to an embodiment of the present disclosure may omit performance of the discovery operation with the AP to which the electronic device is not connectable or the AP which does not satisfy a predetermined reference quality.

An electronic device according to the present disclosure may be any device having a communication function. Examples of the electronic device according to the present disclosure may include one or a combination of a smart phone, a tablet personal computer, a mobile phone, a video phone, an e-book reader, a desktop personal computer, a laptop personal computer, a personal digital assistant, a portable multimedia player, an MP3 player, a mobile medical equipment, an electronic bracelet, an electronic necklace, an electronic accessory, a camera, or a wearable device, an electronic clock, a wrist watch, a smart white appliance (for example, a refrigerator, an air-conditioner, a cleaner, an intelligent robot, a Television (TV), a Digital Video Disk (DVD) player, an audio system, an oven, a microwave oven, a washing machine, an air cleaner, or a digital photo frame), various types of medical equipment (for example, a Magnetic Resonance Angiography (MRA) imaging device, a Magnetic Resonance Imaging (MRI) device, a Computed Tomography (CT) imaging device, an imaging device, or an ultrasound imaging device), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, a vehicle infotainment device, an electronic equipment for a ship (for example, a ship navigation device or a gyro-compass device), an avionics device, a security equipment, an electronic clothing, an electronic key, a camcorder, a game console, a Head-Mounted Display (HMD) a flat panel display device, an electronic album, furniture or a portion of a building/structure including a communication function, an electronic board, an electronic signature receiving device, and a projector. It is obvious that the electronic device according to the present disclosure is not limited to the above-described devices.

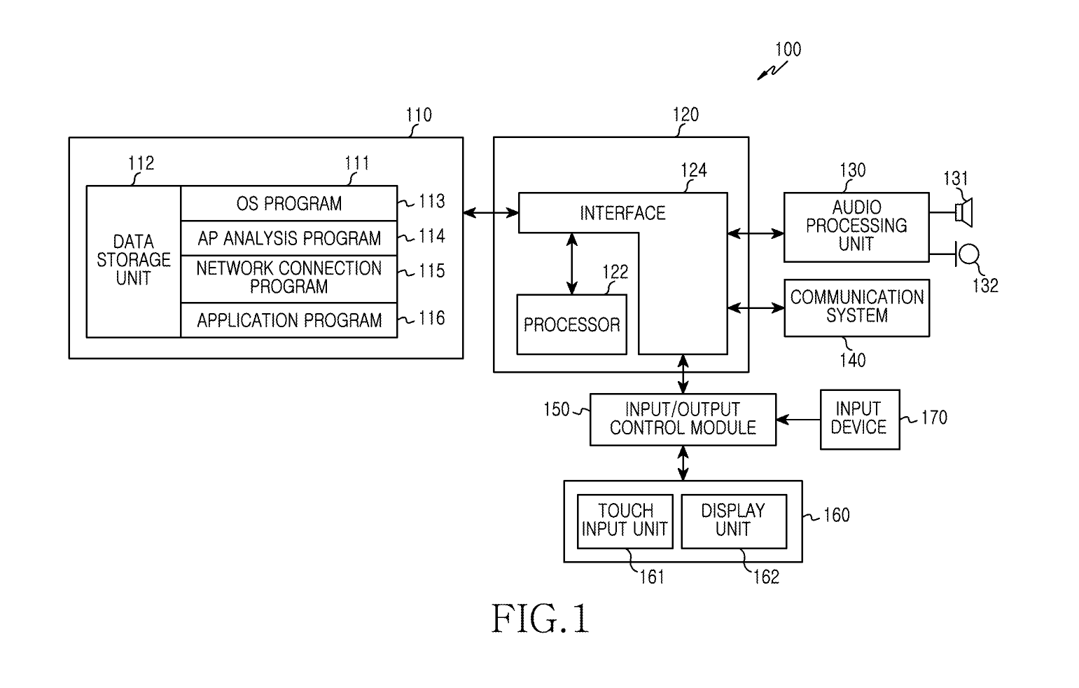

FIG. 1 is a block diagram illustrating an electronic device according to an embodiment of the present disclosure.

Referring to FIG. 1, the electronic device 100 may include a memory 110, a processor unit 120, an audio processing unit 130, a communication system 140, an input/output control module 150, a touchscreen 160, or an input device 170. One or more of such elements may be provided with a plurality of the same element. The respective elements will be described below.

The memory 110 may include a program storage unit 111 for storing a program for controlling an operation of the electronic device 100 and/or a data storage unit 112 for storing data generated during the execution of a program. For example, the data storage unit 112 may store various management data that may be updatable, such as a telephone book, an outgoing message, a received message, or the like. The data storage unit 112 may store information about an AP, to which the electronic device has previously connected, an AP quality threshold value, a credential, information about APs which the discovery operation is applied to, information about APs which the discovery operation is not applied to, and the like, according to various embodiments of the present disclosure.

The AP is an AP that enables wireless Internet connection and may be a hot-spot. The information about an AP, to which the electronic device had previously connected, may be profile information of the AP and may include information about a name of the AP, a coverage area of the AP, a position of the AP, or the like.

The AP to which the electronic device had previously connected may include an AP (for example, an AP supporting a hotspot 2.0) that enables the electronic device to perform automatic scan of and connection to the AP and an AP that requires a manual scan of and connection to the AP.

The AP quality threshold value may be reference information used to determine a quality of an AP identified through a scan operation, and may include a Received Signal Strength Indicator (RSSI), a Basic Service Set (BSS) load threshold value, or the like. For example, the electronic device may determine an AP with which the discovery operation is not to be performed, among scanned APs by using the AP quality threshold value.

The user information, which refers to information necessary for AP connection, may include user identification information (for example, ID or password), information (for example, a Public Land Mobile Network (PLMN), a Service Set Identifier (SSID)) for identifying networks of an operator that is usable by a user, or the like.

AP information about discovery-applied APs or AP information about discovery-unapplied APs may include a list generated based on a result of a previous discovery operation, and may include a list of APs that are matched with user information or a list of APs that are not matched with user information. The list may include network information associated with APs or operator information (for example, a Homogeneous Extended Service Set Identifier (HESSID), an SSID, a PLMN, a Realm, or a connection method).

The program storage unit 111 may include an Operating System (OS) program 113, an AP analysis program 114, a network connection program 115 and at least one application program 116. In this case, the programs stored in the program storage unit 111 may be expressed as an instruction set that is a collection of instructions.

The OS program 113 may include various software elements for controlling general system operations. For example, general system operation controls may include memory control/management, storage hardware (device) control/management, or power control/management. The OS program 113 may also perform a function for enabling smooth communication between various hardware elements (devices) and program elements (modules).

The AP analysis program 114 may include various software elements for scanning neighboring APs and determining an AP with which a discovery operation is performed among the scanned APs.

The AP analysis program 114 may determine an AP with which a discovery operation is to be performed by scanning neighboring APs and checking AP-related information (for example, operator information, AP service information (whether a hot-spot 2.0 is supported), a list of discovery-unapplied APs (or a list of discovery-applied APs), or AP quality information).

For example, the AP analysis program 114 may scan a neighboring AP by using a beacon or probe response which is transmitted by the AP and perform a discovery operation with the scanned AP.

As another example, the AP analysis program 114 may scan neighboring APs by using a beacon or probe response which is transmitted by the APs and omit performance of a discovery operation with an AP registered in a list of discovery-unapplied APs among the neighboring APs.

As another example, the AP analysis program 114 may identify quality information of neighboring APs by using a beacon or probe response which is transmitted by the APs and omit performance of a discovery operation with an AP which does not satisfy a predetermined reference quality.

The AP analysis program 114 may generate a list of discovery-applied APs or a list of discovery-unapplied APs.

The AP analysis program 114 may add an AP that is not matched with user information after a discovery operation, for example, an AP of which the operator is different from a network operator for a user, to a list of discovery-unapplied APs.

The AP analysis program 114 may add an AP that is matched with user information after the discovery operation, for example, an AP of which the operator is identical to a network operator for a user, to a list of discovery-applied APs.

The AP analysis program 114 may update information about a pre-stored list of discovery-applied APs or a pre-stored list of discovery-unapplied APs based on an AP connection operation.

For example, the AP analysis program 114 may determine whether user information is changed. When an AP, which corresponds to a network of an operator corresponding to the changed user information, is included in the list of discovery-unapplied APs, the AP analysis program 114 may remove the AP corresponding to the changed user information from the list of discovery-unapplied APs.

The network connection program 115 may perform a discovery operation with a scanned AP.

The network connection program 115 may perform the discovery operation with only an AP with which the discovery operation is determined to be performed by the AP analysis program 114. For example, the network connection program 115 may perform the discovery operation with an AP included in the list of discovery-applied APs, or an AP having a better quality among an AP having a quality satisfying a predetermined reference and an AP included in the list of discovery-applied APs.

The network connection program 115 may perform the discovery operation of satisfying operator information of each AP by using an ANQP query/response.

The network connection program 115 may compare a result of the discovery operation with pre-stored user information, and perform an operation of connecting to an AP matched with the pre-stored user information.

The application program 116 may include a software element for at least one application program installed in the electronic device. The program for controlling AP connection as described above may be included in the application program 116. This means that a function for performing the discovery operation with an AP satisfying a predetermined condition (for example, an AP satisfying user information or an AP satisfying quality information) among neighboring APs is provided as an application.

The programs stored in the program storage unit 111 may be hardware configurations. For example, the electronic device may include an operating system module, an AP management module, a network connection module, an application program module, or the like.

The program storage unit 111 may include a display program. The display program may include various software elements for providing and displaying graphics on the touchscreen 160. The graphics may include texts, web pages, icons, digital images, videos, and animations.

The display program may include various software elements associated with a user interface.

The display program may perform control to output information about neighboring APs, a result of a discovery operation, information about APs with which the discovery operation is performed, APs with which the discovery operation is not performed or the like.

The processor unit 120 may include at least one processor 122 and/or an interface 124. In this case, the processor 122 or the interface 124 may be integrated in at least one integrated circuit or be implemented as separate elements.

The interface 124 may perform a function of a memory interface for controlling access to the processor 122 and the memory 110. The interface 124 may perform a function of a peripheral interface for controlling connections between input/output peripherals of the electronic device 100 and the processor 122.

The processor 122 may perform control such that the electronic device 100 performs a discovery operation with APs (for example, an AP that satisfies user information and an AP that satisfies quality information) satisfying a predetermined condition from surrounding APs upon connection to an AP by using at least one software program.

The audio processing unit 130 may provide an audio interface between a user and the electronic device 100 through a speaker 131 or a microphone 132.

The communication system 140 may perform a communication function for voice communication or data communication for the electronic device 100. In this case, the communication system 140 may be divided into a plurality of communication sub-modules which support different communication networks. For example, the communication networks may include, but not limited to, a Global System for Mobile Communication (GSM) network, an Enhanced Data GSM Environment (EDGE) network, a Code Division Multiple Access (CDMA) network, a Wideband Code Division Multiple Access (W-CDMA) network, a Long Term Evolution (LTE) network, an Orthogonal Frequency Division Multiple Access (OFDMA) network, a short-range network, such as a wireless Local Area Network (LAN), a Bluetooth network, or Near Field Communication (NFC) network, or the like.

The input/output control module 150 may provide an interface between an input/output device, such as the touchscreen 160 or the input unit 170, and the interface 124.

The touchscreen 160 is an input/output device for performing the input or output of information and may include a touch input unit 161 and a display unit 162.

The touch input unit 161 may provide touch information detected through a touch panel to the processor unit 120 through the input/output control module 150. In this case, the touch input unit 161 may convert the touch information into an instruction form, such as touch_down, touch_move touch_up, or the like to provide the same to the processor unit 122 and generate an input for the AP connection.

The display unit 162 may display state information of the electronic device 100, characters input by the user, moving pictures, still pictures, or the like. For example, the display unit 162 may display an AP connection operation. For example, the display unit 162 may output information about neighboring APs, information about APs included in the list of discovery-applied APs or information about APs included in the list of discovery-unapplied APs.

The input device 170 may provide input data generated by a user's selection to the processor unit 122 through the input/output control module 150. For example, the input device 170 may be configured by including only a control button for control of the electronic device 100. As another example, the input device 170 may be configured by a keypad for receiving input data from a user and generate input for the AP connection.

Although not illustrated, the electronic device 100 may further include elements, such as a broadcast reception module for broadcast reception, a digital sound reproduction module, such as an MP3 module, an image sensor for capturing image data, a proximity sensor module for sensing proximity, software for operations of the elements, and the like.

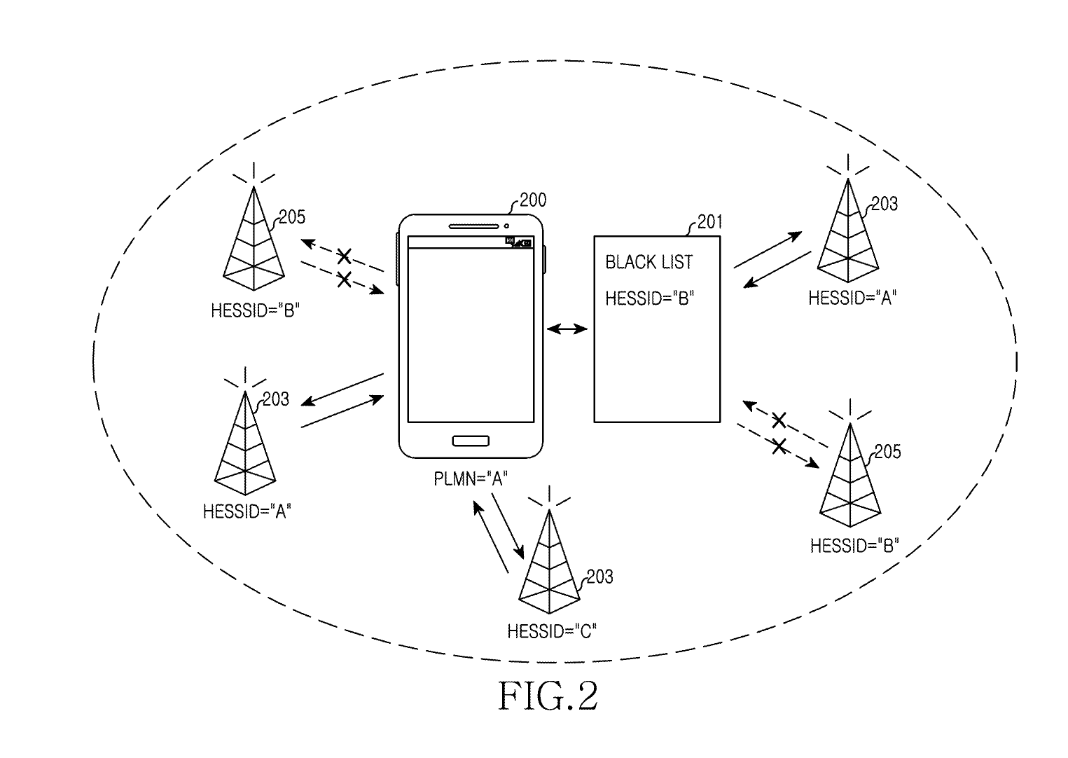

FIG. 2 is a diagram illustrating an AP connection operation of an electronic device according to an embodiment of the present disclosure.

Referring to FIG. 2, the electronic device may connect to a neighboring AP and use a wireless network service.

The electronic device may perform an AP scan operation in order to detect neighboring APs. The electronic device may detect the neighboring APs by using a beacon and a probe response which are received from an AP.

The electronic device may perform an operation of discovering neighboring APs so as to connect to one of the APs. The electronic device may perform a discovery operation and identify service information (for example, 3GPP cellular network information, an NAI Realm list, a roaming consortium list, a domain name list, venue name information, an operator friendly name, IP address type availability information, WAN metrics, connection capability, operating class indication, network authentication type information, or the like). For example, the electronic device may perform an operation (ANQP query/response) of requesting information about APs for providing a wireless network from an ANQP server and identify operator information of the respective APs.

The electronic device may connect to an AP matched with the user information as a result of the discovery operation. For example, the electronic device may compare network operator information stored in a Subscriber Identity Module (SIM) card with the operator of an AP identified through the discovery operation and connect to an AP that corresponds to the operator identical to the network operator information.

In the embodiment, the electronic device may not perform the discovery operation with an AP to which the electronic device is not connectable. The electronic device may generate a list of APs which are not matched with user information by using the result of the discovery operation and use a pre-generated list of APs upon AP connection. For example, the electronic device may not perform the discovery operation with the APs included in the list among APs scanned through an AP scan operation.

As illustrated in FIG. 2, the electronic device 200 may store a list 201 of APs to which the electronic device is not connectable, based on a previous discovery operation. The electronic device 200 may store the HESSID and PLMN information of the APs to which the electronic device is not connectable. The electronic device 200 may identify the HESSID of a neighboring AP through the AP scan operation. The HESSID is information used to discriminate network operators from one another, and a plurality of APs provided by one operator may have the same HESSID as one another.

The electronic device 200 may not perform the discovery operation with APs 205 corresponding to an HESSID that is registered in a pre-stored list, and may perform the discovery operation with APs 203 corresponding to HESSIDs that are not registered in the pre-stored list.

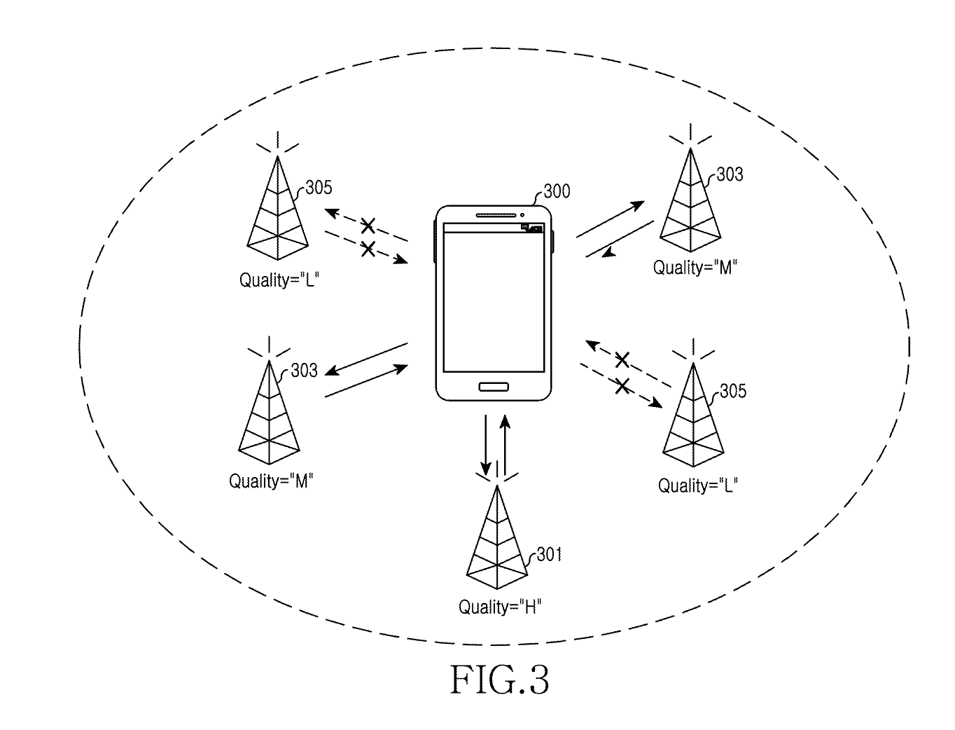

FIG. 3 is a diagram illustrating an AP connection operation of an electronic device according to an embodiment of the present disclosure.

Referring to FIG. 3, the electronic device may connect to a neighboring AP and use a wireless network service.

The electronic device may perform an AP scan operation in order to detect a neighboring AP. The electronic device may detect a neighboring AP by using a beacon and a probe response which are received from the AP.

The electronic device may perform the discovery operation with a neighboring AP in order to connect to the AP.

The electronic device may not perform the discovery operation with an AP to which the electronic device is not connectable. The electronic device may determine the quality of an AP through the AP scan operation. For example, the electronic device may measure a received signal strength. As another example, the electronic device may receive BSS load information from each AP. The electronic device may identify network load, channel efficiency, the number of connected devices, or the like by checking information (BSS link) included in the beacon and probe response messages.

The electronic device may compare a received signal strength or load information (network load, channel efficiency, or the number of connected devices) with a predefined threshold value, and may not perform the discovery operation with an AP that does not satisfy a certain condition.

FIG. 3 illustrates a situation where the electronic device 300 classifies qualities of APs into a high quality, a middle quality, and a low quality, and does not perform the discovery operation with an AP 305, of which the quality is the low quality, and performs the discovery operation with APs 301 and 303, each of which has a quality that is equal to or larger than the “middle” quality.

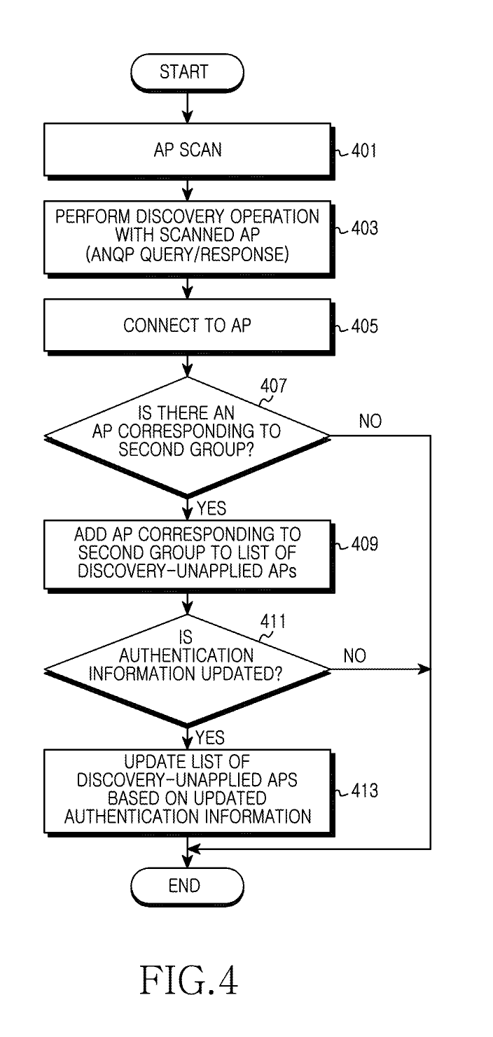

FIG. 4 is a flowchart illustrating an operation of generating an AP list in an electronic device according to an embodiment of the present disclosure.

Referring to FIG. 4, the electronic device may perform an AP scan in operation 401. That is, the electronic device may scan neighboring APs by receiving a beacon and a probe response message from the APs.

In operation 403, the electronic device may perform a discovery operation with the scanned APs. The electronic device may perform the discovery operation of transmitting a query requesting operator information of respective APs to and receiving a response from an ANQP server in response to the query to identify the operator information of the respective APs.

In operation 405, the electronic device may connect to an AP using a result of the discovery operation. The electronic device may identify connectable APs by comparing the operator information of the APs identified through the result of the discovery operation with user information and attempt to connect to an AP satisfying a predetermined condition.

In operation 407, the electronic device may determine whether there is an AP to which the electronic device is not connectable. In this case, the AP to which the electronic device is not connectable may be an AP that is determined not to be matched with the pre-stored user information as the result of the discovery operation.

In operation 409, the electronic device may add the AP, to which the electronic device is not connectable, to a list of discovery-unapplied APs. The list of discovery-unapplied APs is compared with scanned APs upon AP connection. The electronic device may not perform the discovery operation with APs included in the discovery-unapplied APs.

In operation 411, the electronic device may determine whether authentication information is updated. The update of the authentication information may include changing of network information that is usable and pre-stored. For example, the operator of the electronic device may be changed.

In operation 413, the electronic device may update the list of discovery-unapplied APs based on the updated authentication information.

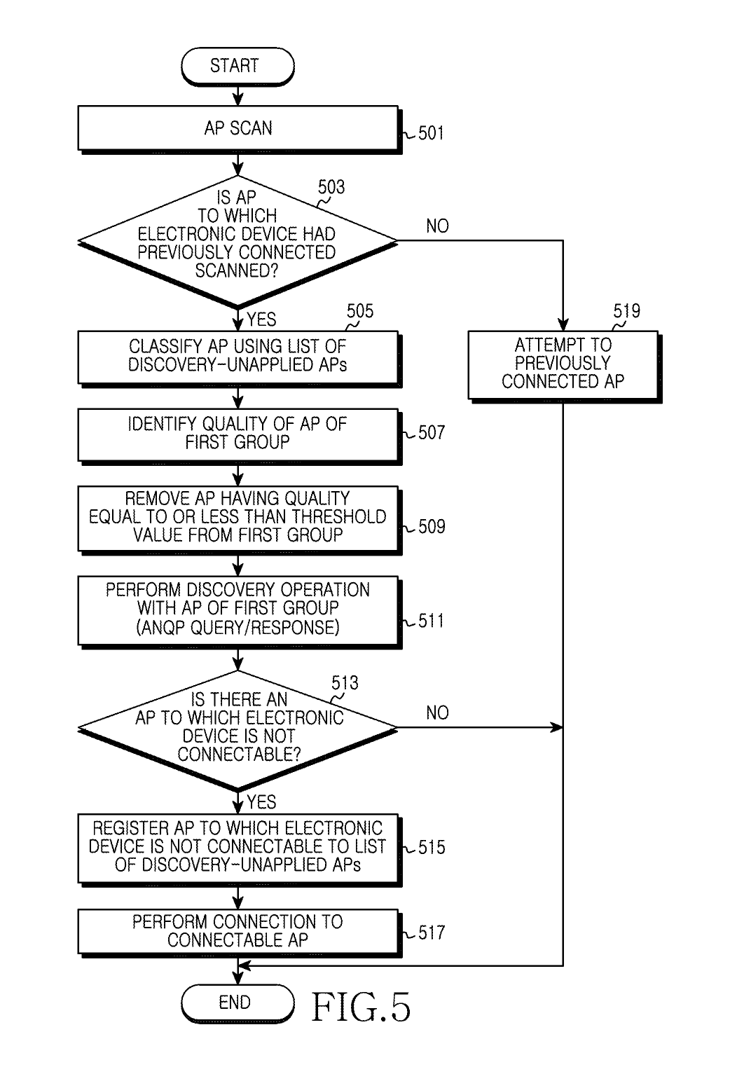

FIG. 5 is a flowchart illustrating an operation of connecting to an AP in an electronic device according to an embodiment of the present disclosure.

Referring to FIG. 5, the electronic device may perform an AP scan in operation 501. The electronic device may scan a neighboring AP by receiving a beacon and a probe response message from the AP. The beacon or the probe response message received from the AP may include information indicating the quality of an AP. For example, the electronic device may identify the HESSID and quality information of the neighboring AP through the AP scan operation. In this case, the quality information may include network load, channel utilization, the number of connected devices for a BSS, and the like.

In operation 503, the electronic device may determine whether there is an AP to which the electronic device had previously connected, among scanned APs. For example, the electronic device may determine whether there is an AP registered in a WiFi profile, among the scanned APs. The AP to which the electronic device had previously connected, may include an AP (for example, an AP supporting a hotspot 2.0) that enables the electronic device to perform automatic scan of and connection to the AP and an AP that requires manual scan of and connection to the AP.

When the electronic device scans an AP to which the electronic device had previously connected, the electronic device may attempt to connect to the AP in operation 519.

In operation 505, the electronic device may classify scanned APs using a list of discovery-unapplied APs. The electronic device may define APs which are not included in the list of discovery-unapplied APs among the scanned APs as APs of the first group. The first group may be a group of APs with which the discovery operation is performed.

The electronic device may classify the scanned APs based on the HESSIDs thereof. There may be a plurality of APs having the same HESSID as each another. The APs having the same HESSID may correspond to one network operator. The electronic device may exclude APs corresponding to HESSIDs included in the list of discovery-unapplied APs from the first group.

In operation 507, the electronic device may identify qualities of APs included in the first group. The electronic device may identify a received signal strength or load information of each AP of the first group and compare the same with a pre-stored threshold.

In operation 509, the electronic device may remove an AP having a quality equal to or less than the threshold from the first group. The electronic device may remove an AP that does not satisfy a predetermined reference among APs which are not included in the list of discovery-unapplied APs from the first group, and may not perform the discovery operation with the AP.

In operation 511, the electronic device may perform the discovery operation with the APs included in the first group. The AP of the first group is not included in the list of discovery-unapplied APs, and may be an AP satisfying a quality greater than predetermined reference.

In operation 513, the electronic device may determine whether there is an AP to which the electronic device is not connectable based on a result of the discovery operation.

The electronic device may identify an AP that is not matched with the user information stored in a SIM card, for example, an AP corresponding to an operator that is not equal to a network operator associated with the user.

In operation 515, the electronic device may register the AP, to which the electronic device is not connectable, to the list of discovery-unapplied APs. After performance of the discovery operation, the electronic device may add the AP, to which the electronic device is not connectable, to the list of discovery-unapplied APs, and enable the AP to perform the discovery operation upon AP connection.

In operation 517, the electronic device may perform connection to an AP to which the electronic device is connectable.

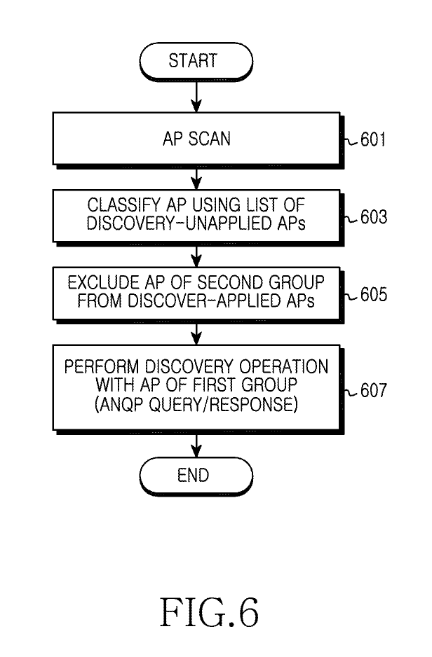

FIG. 6 is a flowchart illustrating an operation of connecting to an AP in an electronic device according to an embodiment of the present disclosure.

Referring to FIG. 6, the electronic device may perform an AP scan in operation 601.

In operation 603, the electronic device may classify APs using a list of discovery-unapplied APs. The list of discovery-unapplied APs may be a list of APs provided by operators, to which the electronic device is not connectable, based on a previous discovery operation.

The electronic device may define APs that are not included in the list of discovery-unapplied APs among scanned APs as APs of the first group, and define APs that are included in the list of discovery-unapplied APs among the scanned APs as APs of the second group. The first group may be a group of APs with which the discovery operation is performed.

In operation 605, the electronic device may not perform the discovery operation with the APs of the second group.

In operation 607, the electronic device may perform the discovery operation with the APs included in the first group.

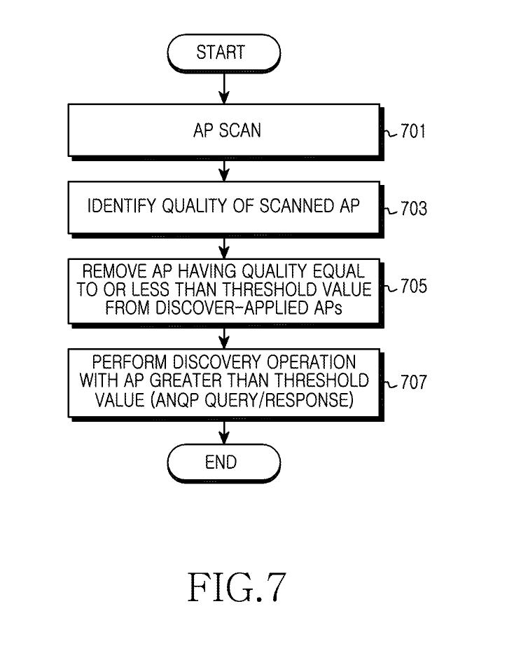

FIG. 7 is a flowchart illustrating an operation of connecting to an AP in an electronic device according to an embodiment of the present disclosure.

Referring to FIG. 7, the electronic device may perform an AP scan in operation 701. The electronic may receive a beacon or a probe response message along with information indicating the quality of an AP from the AP.

In operation 703, the electronic device may identify qualities of scanned APs. The electronic device may identify a received signal strength or load information of each scanned AP and compare the same with a pre-stored threshold.

In operation 705, the electronic device may exclude an AP having a quality equal to or less than the threshold from a list of discovery-applied APs.

In operation 707, the electronic device may perform the discovery operation with the APs greater than the threshold.

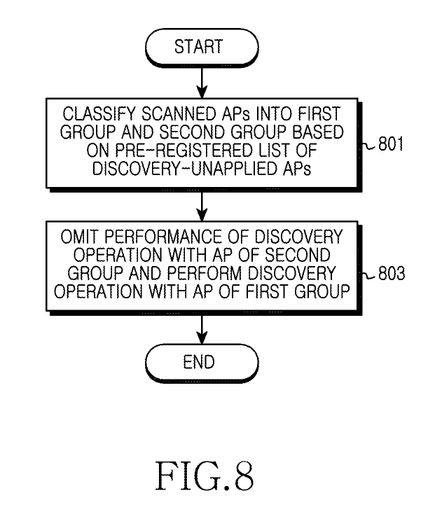

FIG. 8 is a flowchart illustrating an operation of connecting to an AP in an electronic device according to an embodiment of the present disclosure.

Referring to FIG. 8, in operation 801, the electronic device may classify scanned APs into a first group and a second group based on a pre-registered list of discovery-unapplied APs.

In operation 803, the electronic device may omit performance of a discovery operation with an AP of the second group and may perform the discovery operation with an AP of the first group.

The pre-registered list of discovery-unapplied APs may include a list of APs which are not matched with user information.

The discovery operation may include an operation of identifying operator information of APs by requesting information about APs from an ANQP server.

Scanned APs are classified into the first group and the second group based on the pre-registered list of discovery-unapplied APs and an operation of identifying qualities of APs included in the first group and an operation of excluding APs, each of which the quality is equal to or less than a predetermined reference, from the first group, may be performed.

The service quality of an AP may include at least one of a received signal strength, network load, the number of connected devices, and the like.

After the discovery operation is performed with the APs included in the first group, an operation of registering APs, to which the electronic device is not connectable, in the pre-registered list of discovery-unapplied APs.

When user information is changed, an operation of updating the pre-registered list of discovery-unapplied APs based on the changed user information may be performed. The changing of the user information may include changing of the operator of an available network.

Each of the above-descried elements of the electronic device according to the present disclosure may be configured by one or more components and the name of each element may vary depending on the type of an electronic device. The electronic device according to the present disclosure may be configured by including at least one of the above-described elements, and some elements may be omitted from or an additional element may be further included in the electronic device. In addition, some of the elements of the electronic device according to the present disclosure may be combined into one entity and perform functions of relevant elements before combination.

The term “element”, for example, “module” as used herein may refer to a unit including one or a combination of two or more among, for example, hardware, software and firmware. The “module” may be used interchangeably with, for example, the term “unit”, “logic”, “logical block”, “component”, or “circuit”. The “module” may be a smallest unit or part of an integrally formed component. The “module” may be a smallest unit or a part thereof which performs one or more functions. The “module” may be implemented mechanically or electronically. For example, the “module” according to the present disclosure may include at least one of an Application-Specific Integrated Circuit (ASIC) chip, Field Programmable Gate Arrays (FPGA), a programmable-logic device, and the like, which perform certain operations and that are presently well known or later-developed.

According to the various embodiments, at least a part of the apparatus (for example, modules or functions thereof) or the method (for example, operations) according to the present disclosure may be implemented by an instruction stored in a computer-readable storage media as a programming module for example. When the instruction is executed by one or more processors, the processor may perform a function corresponding to the instruction. The computer-readable storage media may be, for example, a memory. At least a part of the programming module may be implemented (for example, executed) by the processor for example. At least a part of the programming module may include, for example, a module, a program, a routine, a set of instructions and/or a process which performs one or more functions.

Examples of the computer-readable recording medium include magnetic media such as hard disks, floppy disks and magnetic tapes, optical media such as CD-ROMs and DVDs, magneto-optical media such as floptical disks, and hardware devices such as Read-Only Memories (ROMs), Random-Access Memories (RAMs) and flash memories that are especially configured to store and execute program commands (for example: programming module). The program commands may include machine language codes that may be generated by a compiler, and high-level language codes that may be executed by a computer by using an interpreter. The hardware apparatus may be configured to operate as one or more software modules in order to perform operations according to the present disclosure, or visa versa.

The module or programming module according to the present disclosure may include one or more elements among the above-described elements or emit some elements among the above-described elements, or further include another element. The operations performed by the module, programming module, or another element according to the present disclosure may be performed in a sequential manner, a parallel manner, a repetitive manner, or a heuristic manner. Furthermore, some operations may be performed in another order or be omitted, or another operation may be included.

According to various embodiments, there is provided a storage medium for storing instructions, that, when executed by at least one processor, cause the at least one processor to perform at least one operation, the at least one operation include generating a list of APs, to which an electronic device fails to connect, upon AP connection and, when APs are scanned, performing a discovery operation with an AP not included in the list among the scanned APs.

The at least one operation may include updating a list of APs to which the electronic device is not connectable based on a result of the discovery operation after performance of the discovery operation.

According to the various embodiments of the present disclosure, performance of a discovery operation with an unnecessary AP is omitted, thereby improving network discovery performance of the electronic device and preventing battery consumption.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
generating a list of Access Points (APs) to which the electronic device fails to connect upon AP connection; and
when APs are scanned, performing a discovery operation with APs which are not included in the list among the scanned APs.

2. The method of claim 1, wherein the list includes a list of APs which are not matched with user information.

3. The method of claim 1, wherein the discovery operation includes an operation of requesting information about APs from an Access Network Query Protocol (ANQP) server and identifying operator information of the APs.

4. The method of claim 1, further comprising:
classifying scanned APs into a first group and a second group based on the list;
identifying qualities of APs of the first group; and
excluding an AP having a quality equal to or less than a predetermined reference from the first group,
wherein the first group is a group of APs which are not included in the list.

5. The method of claim 4, wherein the quality of the AP may include at least one of a received signal strength, a network load, and a number of connected devices.

6. The method of claim 1, further comprising registering an AP, to which the electronic device is not connectable, to the list, after the discovery operation is performed with an AP of the first group.

7. The method of claim 1, further comprising, when user information is changed, updating the list based on the changed user information,
wherein the changing of the user information includes changing of an operator of an available network.

8. An electronic device comprising:
a memory configured to store user information and a list of discovery-unapplied APs; and
at least one processor,
wherein the at least one processor is configured to generate a list of Access Points (APs) to which the electronic device fails to connect upon AP connection and to perform a discovery operation with APs which are not included in the list.

9. The electronic device of claim 8, wherein the processor defines APs which are not included in the list of discovery-unapplied APs among APs scanned upon AP connection as discovery-applied APs in a state in which the list of discovery-unapplied APs is generated.

10. The electronic device of claim 9, wherein the processor identifies qualities of the APs defined as the discovery-applied APs and excludes an AP having a quality equal to or less than a predetermined reference from the discovery-applied APs.

11. The electronic device of claim 10, wherein the processor identifies the qualities of the APs by checking at least one of a received signal strength, a network load, and a number of connected devices, which are included in a beacon or a probe response message received upon scanning of APs.

12. The electronic device of claim 8, wherein the processor performs a discovery operation of requesting information about an AP from an Access Network Query Protocol (ANQP) server and identifying operator information of the AP.

13. The electronic device of claim 8, wherein the processor updates, when the user information is changed, the list of discovery-unapplied APs, which is previously registered, based on the changed user information.

14. The electronic device of claim 8, wherein the processor uses user identification information set with respect to an AP or information for identifying a network of an operator which is usable by a user as the user information.

15. The electronic device of claim 14, wherein the processor uses at least one of a Public Land Mobile Network (PLMN) and a Service Set Identifier (SSID) as the information for identifying a network.

16. The electronic device of claim 8, wherein the processor scans neighboring APs, classifies the scanned APs according to a Homogeneous Extended Service Set Identifier (HESSID), and identifies an AP to which the electronic device is not connectable.

17. The electronic device of claim 8, wherein the processor registers at least one of a Homogeneous Extended Service Set Identifier (HESSID) and a Service Set Identifier (SSID) of the AP to which the electronic device is not connectable to the list of discovery-unapplied APs when the list of discovery-unapplied APs is generated.

18. A non-transitory computer-readable recording medium storing one or more programs for:
generating a list of Access Points (APs) to which an electronic device fails to connect upon AP connection; and
when APs are scanned, performing a discovery operation with APs which are not included in the list among the scanned APs.

19. The non-transitory computer-readable recording medium of claim 18, wherein the computer-readable recoding medium stores a program for updating a list of discovery-unapplied APs based on a result of the discovery operation after performance of the discovery operation.

20. An electronic device, comprising:
a memory configured to store user information and a list of discovery-unapplied APs;
a network connection module configured to perform a discovery operation with neighboring APs;
an AP analysis module configured to identify Access Points (APs), to which the electronic device is not connectable, based on a result of the discovery operation and user information upon AP connection and to generate a list of discovery-unapplied APs with respect to the APs to which the electronic device is not connectable; and
at least one processor operatively coupled to the network connection module and the AP analysis module.
